(19) United States
(12) Patent Application Publication
(10) Pub. No.: US 2005/0105853 A1
(43) Pub. Date: May 19, 2005

(54) Method and apparatus for dual tapering an optical waveguide

(76) Inventors: Ansheng Liu, Cupertino, CA (US); Doron Rubin, Givataim (IL)

Correspondence Address: James Y. Go;BLAKELY, SOKOLOFF, TAYLOR & ZAFMAN LLP, Seventh Floor, 12400 Wilshire Boulevard, Los Angeles, CA, 90025, US

(21) Appl. No.: 10/713,879

(22) Filed: Nov. 13, 2003

(51) Int. Cl. G02B 6/26; G02B 6/42; G02B 6/10

(52) U.S. Cl. 385/43; 385/39; 385/129

(57) ABSTRACT

An apparatus and method for reducing a mode size of an optical beam with a dual taper waveguide device. In one embodiment, an apparatus according to embodiments of the present invention includes a buried tapered waveguide disposed in a semiconductor layer. The apparatus further includes a tapered rib waveguide disposed in the semiconductor layer proximate to the buried tapered waveguide. The tapered rib waveguide includes a rib portion adjoining a slab portion. The slab portion of the rib waveguide adjoins the buried tapered waveguide. An optical beam is directed into a larger end of the buried tapered waveguide and the tapered rib waveguide. The buried tapered waveguide is tapered to guide the optical beam therethrough into the slab portion of the rib waveguide.

### BACKGROUND OF THE INVENTION

1. Field of the Invention

The present invention relates generally to optics and, more specifically, the present invention relates to optical waveguide tapers.

2. Background Information

The need for fast and efficient optical-based technologies is increasing as Internet data traffic growth rate is overtaking voice traffic pushing the need for optical communications. Transmission of multiple optical channels over the same fiber in the dense wavelength-division multiplexing (DWDM) systems and Gigabit (GB) Ethernet systems provide a simple way to use the unprecedented capacity (signal bandwidth) offered by fiber optics. Commonly used optical components in the system include wavelength division multiplexed (WDM) transmitters and receivers, optical filter such as diffraction gratings, thin-film filters, fiber Bragg gratings, arrayed-waveguide gratings, optical add/drop multiplexers, lasers and optical switches.

Many of these building block optical components can be implemented in semiconductor devices. As such, these devices are typically connected to an optical fiber and it is therefore important to obtain an efficient coupling of light between the fiber and the semiconductor device containing the optical components. Light is typically propagated through the optical fibers and optical waveguides in semiconductor devices as a single mode. Three-dimensional tapered waveguides or mode size converters are important to realize efficient light coupling between a single mode fiber and a single mode semiconductor waveguide device because semiconductor waveguide devices usually have smaller mode sizes compared to optical fiber mode sizes. This is usually because of the large index contrast of semiconductor waveguide systems and the required smaller waveguide dimensions for the device performance such as high speed in a silicon based photonic device.

Previous attempts at three-dimensional tapered waveguides or mode size converters include various tapering schemes and fabrication methods that are for example based on gray scale lithography technology, which requires a complicated etch process. Other attempts include taper methods that are difficult to combine with the electrically active photonic device processes, which typically involves many back-end process steps.

### BRIEF DESCRIPTION OF THE DRAWINGS

The present invention is illustrated by way of example and not limitation in the accompanying figures.

FIG. 1 is an illustration of one embodiment of a dual taper waveguide device including a buried tapered waveguide and a tapered rib waveguide in accordance with the teachings of the present invention.

FIG. 2 is a side view diagram of one embodiment of a dual taper waveguide device illustrating a mode of an optical beam propagating through the buried tapered waveguide being directed up and into a slab portion of a tapered rib waveguide adjoining the buried tapered waveguide in accordance with the teachings of the present invention.

FIG. 3 is a cross section view of one embodiment of a larger or input end of a dual taper waveguide device in accordance with the teachings of the present invention.

FIG. 4 is a cross section view of one embodiment of a smaller or output end of a dual taper waveguide device in accordance with the teachings of the present invention.

FIG. 5 is a top view diagram illustrating one embodiment of three different masks used when fabricating a dual taper waveguide in accordance with the teachings of the present invention.

FIG. 6 is a side view diagram illustrating one embodiment of a silicon-on-insulator (SOI) wafer during fabrication of a dual taper waveguide device in accordance with the teachings of the present invention.

FIG. 7 is a side view diagram illustrating one embodiment of an SOI wafer during fabrication of the dual taper waveguide device after a first semiconductor layer is etched with a first mask in accordance with the teachings of the present invention.

FIG. 8 is a side view diagram illustrating one embodiment of an SOI wafer during fabrication of the dual taper waveguide device after a second semiconductor layer is etched with a second mask in accordance with the teachings of the present invention.

FIG. 9 is a front view diagram illustrating the tip of one embodiment of a dual taper waveguide device in an SOI wafer during fabrication of the dual taper waveguide device after the second semiconductor layer is etched with the second mask in accordance with the teachings of the present invention.

FIG. 10 is a side view diagram illustrating one embodiment of an SOI wafer during fabrication of a dual taper waveguide device after an insulating layer is grown in accordance with the teachings of the present invention.

FIG. 11 is a front view diagram of the sharpened tip of one embodiment of a dual taper waveguide device in an SOI wafer during fabrication of the dual taper waveguide device after the second semiconductor layer is etched with the second mask in accordance with the teachings of the present invention.

FIG. 12 is a side view diagram illustrating one embodiment of an SOI wafer during fabrication of a dual taper waveguide device after epitaxial lateral overgrowth (ELO) silicon is grown in accordance with the teachings of the present invention.

FIG. 13 is a front view diagram illustrating the sharpened tip of one embodiment of an SOI wafer during fabrication of a dual taper waveguide device after the ELO silicon is grown in accordance with the teachings of the present invention.

FIG. 14 is a front view diagram illustrating a smaller end of a tapered rib waveguide formed during fabrication of a dual taper waveguide device after the tapered rib waveguide has been patterned in accordance with the teachings of the present invention.

FIG. 15 is a block diagram illustration of one embodiment of a system including one embodiment a semiconductor device including a dual taper waveguide device and a photonic device according to embodiments of the present invention.

### DETAILED DESCRIPTION

Methods and apparatuses reducing or converting a mode size of an optical beam with a dual taper waveguide device are disclosed. In the following description numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments. In addition, it is appreciated that the figures provided herewith are for explanation purposes to persons ordinarily skilled in the art and that the drawings are not necessarily drawn to scale.

In one embodiment of the present invention, a novel dual taper waveguide that can be used to efficiently couple light between single mode fiber and a silicon photonic device is disclosed. The taper process can be completed according to embodiments of the present invention before photonic device processes in a semiconductor layer and therefore, back-end process compatibility problems are reduced.

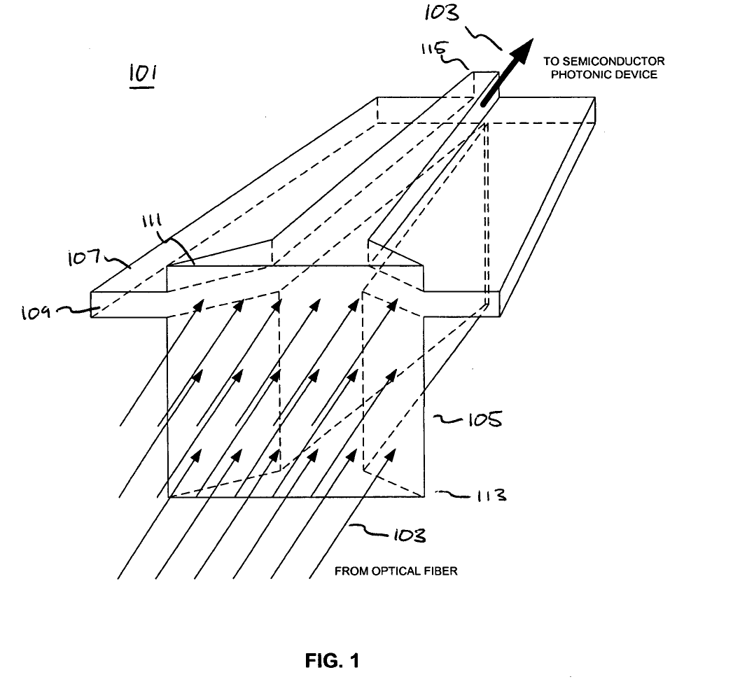

In one embodiment of the present invention, a semiconductor-based dual taper waveguide device is provided in a fully integrated solution on a single integrated circuit chip. As illustrated in FIG. 1, one embodiment of a dual taper waveguide device 101 disposed in semiconductor material in accordance with the teachings of the present invention includes a buried tapered waveguide 105 adjoining a tapered rib waveguide 107. The tapered rib waveguide 107 includes a slab portion 109 and a rib portion 111. As shown in FIG. 1, an optical beam 103 is directed into a larger end 113 of dual taper rib waveguide. In one embodiment, the mode size of optical beam 103 has a mode size such that portions of optical beam 103 propagate through both buried tapered waveguide 105 and tapered rib waveguide 107 when entering dual taper waveguide device 101 at the larger end 113.

In one embodiment, the slab portion 109 of the tapered rib waveguide 107 adjoins the buried tapered waveguide 105 such that the buried tapered waveguide 105 is adapted to direct the mode of the portion of the optical beam 103 propagating through the buried tapered waveguide 105 into the slab portion 109 of the tapered rib waveguide 107. Therefore, the mode size of optical beam 103 is reduced such that substantially all of optical beam 103 with the reduced mode size is output from dual taper waveguide device 101 from the smaller end 115 of tapered rib waveguide 107.

In one embodiment, optical beam 103 is received at the larger end 113 of dual taper waveguide device 101 from an optical fiber and optical beam 103 is then directed from the smaller end 115 of dual taper waveguide device 101 to a photonic device disposed in the same semiconductor material layer as dual taper waveguide device 101 such that dual taper waveguide device 101 is provided in a fully integrated solution on a single integrated circuit chip.

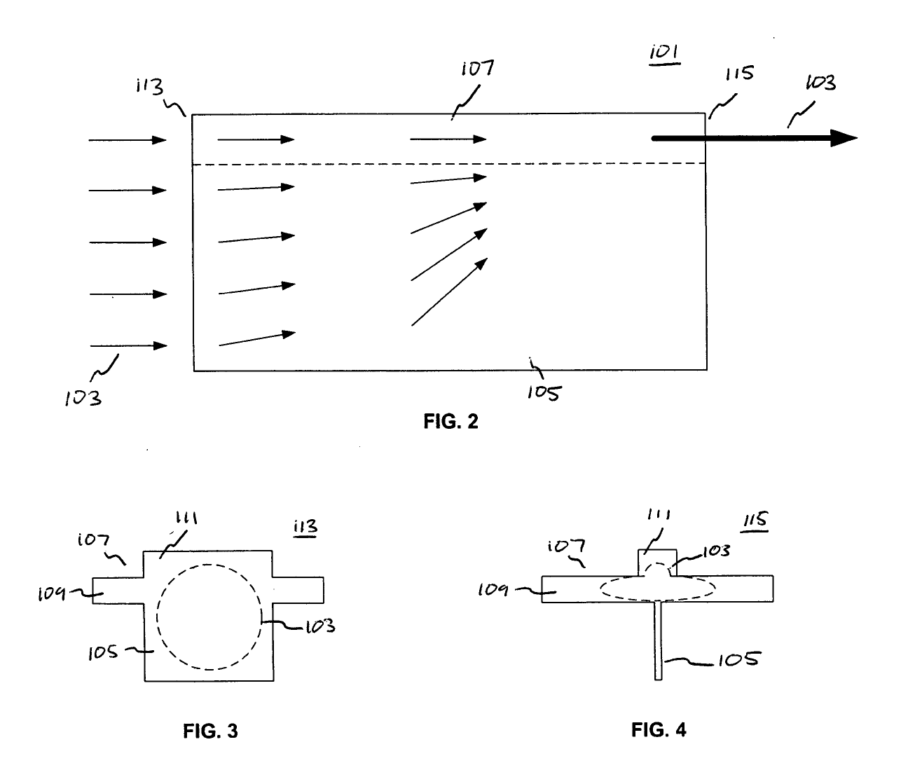

FIG. 2 is a side view diagram of one embodiment of a dual taper waveguide device 101 illustrating the size of a mode of an optical beam 103 propagating through dual taper waveguide device 101 being reduced when being directed from a larger end 113 of the dual taper waveguide device 101 to the smaller end 115 of the dual taper waveguide device 101. As shown, dual taper waveguide device 101 includes a buried tapered waveguide 105, which in one embodiment is fabricated as a two-dimensional taper buried in a semiconductor layer of a silicon-on-insulator (SOI) wafer in accordance with the teaching of the present invention. In one embodiment, dual taper waveguide device 101 further includes a tapered rib waveguide 107, which in one embodiment is fabricated as a two-dimensional tapered waveguide adjoining buried tapered waveguide 105. In one embodiment, tapered rib waveguide 107 includes a rib portion 111 and a slab portion 109, as illustrated above for example in FIG. 1, which is adjoining buried tapered waveguide 105 in accordance with the teachings of the present invention.

As the shown in the depicted embodiment, the mode of the portion of optical beam 103 propagating through buried tapered waveguide 105 is pushed or directed into tapered rib waveguide 107 as optical beam 103 propagates along buried tapered waveguide 105. In one embodiment, the mode of optical beam 103 that is directed from buried tapered waveguide 105 is directed into the slab portion of tapered rib waveguide 107. As such, the mode size of optical beam 103 is reduced such that substantially all of optical beam 103 is directed out the smaller end 115 of dual taper waveguide device 101 through tapered rib waveguide 107.

To illustrate, FIG. 3 is a cross section view of one embodiment of the larger end 113 of dual taper waveguide device 101 in accordance with the teachings of the present invention. As shown, the intensity distribution of optical beam 103 is such that it is propagated through both buried tapered waveguide 105 and tapered rib waveguide 107 at larger end 113.

FIG. 4 shows a cross section view of one embodiment of the smaller end 115 of dual taper waveguide device 101 in accordance with the teachings of the present invention. In one embodiment, the rib portion 111 of tapered rib waveguide 115 at smaller end 115 is reduced in size, as shown in FIG. 4, when compared to rib portion 111 of tapered rib waveguide 115 at larger end 113, as shown in FIG. 3. The buried tapered waveguide 105 at smaller end 115 is reduced in size to a sharp tip, as shown in FIG. 4, when compared buried tapered waveguide 105 at larger end 113, as shown in FIG. 3. As shown in the embodiment depicted in FIG. 4, the portion of the mode of optical beam 103 originally propagating through buried tapered waveguide 105 has been directed or pushed up from buried tapered waveguide 105 into tapered rib waveguide 107 through rib portion 109 at smaller end 115.

Accordingly, the mode size of optical beam 103 has been reduced with dual taper waveguide device 101 in accordance with the teachings of the present invention.

In one embodiment, the tip width at the smaller end 115 of buried tapered waveguide 105 is fabricated to be as small or sharp as possible in accordance with the teachings of the present invention, which is typically determined by the lithographic resolution and etch process. In one embodiment, the tip width at the smaller end 115 of buried tapered waveguide 105 can be made even sharper or smaller by including an insulating layer in the semiconductor material layer, which will be described in greater detail below, in accordance with the present invention.

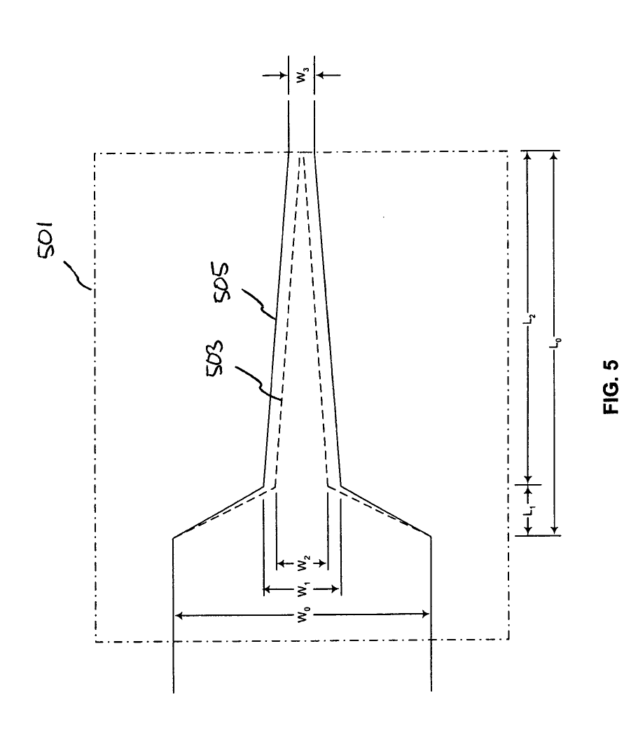

To illustrate, top view illustrations of the masks used to fabricate a dual taper waveguide device 101 are shown in FIG. 5. Three masks are illustrated in FIG. 5, the first of which is mask 501, which is the largest. Mask 503 is used when fabricating buried tapered waveguide and mask 505 is used when fabricating the rib portion 111 of tapered rib waveguide 107.

As shown in the depicted embodiment, mask 503 is shaped such that buried tapered waveguide 105 will have the length of L₀. In addition, mask 503 is shaped such that buried tapered waveguide 105 will have first and second taper regions. The first taper region of buried tapered waveguide 105 will taper at a first taper rate from the width of W₀ to a width of W₂ over a length of L₁. In the second taper region of buried tapered waveguide 105, the buried tapered waveguide 105 will taper at a second rate from a width of W₂ to a sharp point over a length of L₂. In one embodiment, the width of the sharp point is determined in part by the lithographic resolution and etch process. As shown in the embodiment depicted in FIG. 5, the first and second taper rates are different. For example, in one embodiment, Wo is approximately 10 μm, W₂ is approximately 3 μm and L₁ is approximately 100-200 μm for the first taper region. In the second taper region, the buried tapered waveguide 105 will taper at a second rate from approximately 3 μm to the sharp point over approximately 1.3-1.4 mm. In one embodiment, the total length L₀ is approximately 1.5 mm.

With regard to mask 505, it is shaped such that the rib portion 111 of tapered rib waveguide 107 will also have a length of L₀ and shaped such that tapered rib waveguide 105 will have first and second taper regions. The first taper region of the rib portion 111 of the tapered rib waveguide 107 will taper at a first taper rate from the width of W₀ to a width of W₁ over the length of L₁ and the second taper region will taper at a second rate from the width of W₁ to a width of W₃ over the length of L₂. In one embodiment, W₁ is slightly larger than W₂ and W3 is approximately 1.8-1.9 μm.

In one embodiment, it is noted that a relatively short taper length is used for the first taper region, when the dual waveguide taper device 101 for example tapers from for example 10 μm to 3 μm, and a longer taper is used for the second taper region because both horizontal and vertical mode conversion occurs in the second taper region and the optical radiation loss of the dual taper waveguide device 101 in one embodiment depends on the taper length. By including the first and second taper regions with different taper rates, dual taper waveguide device 101 is shorter compared to other taper devices with a single taper rate. As a result, dual taper waveguide device 101 is able to reduce the size of the mode with less radiation loss compared to other longer tapers. In one embodiment, simulation results have shown that a small taper loss of only approximately 0.26 dB can be obtained with an embodiment of a dual taper device 101 having an approximately 1.5 mm taper length tapering from approximately 10×10 μm to approximately 1.8×1.9 μm in accordance with the teachings of the present invention.

It is appreciated that the specific dimensions and taper rates illustrated herewith are provided for explanation purposes and that other dimensions or rates may also be utilized in accordance with the teachings of the present invention.

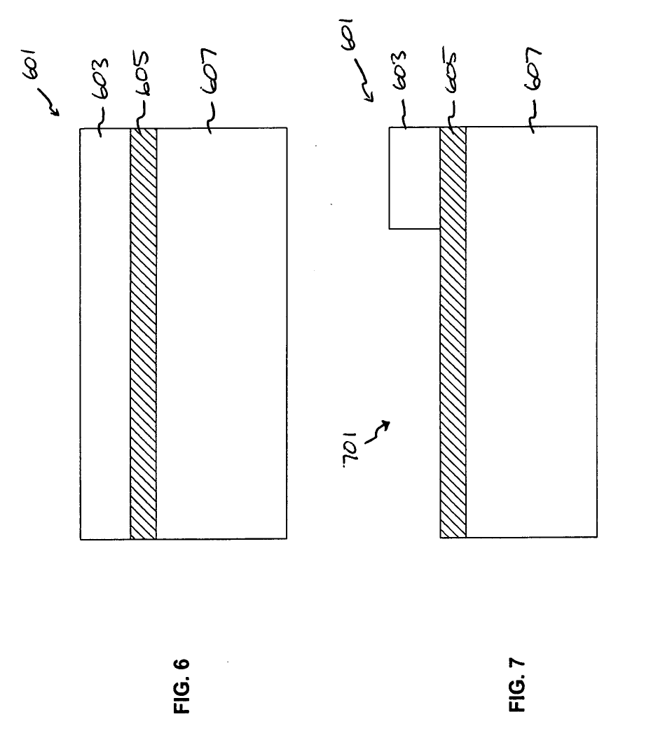

FIGS. 6 through 14 are diagrams illustrating one embodiment of a process to fabricate a dual taper waveguide device 101 in accordance with the teachings of the present invention. In particular, FIG. 6 is a side view diagram illustrating one embodiment of a silicon-on-insulator (SOI) wafer 601 during fabrication of a dual taper waveguide device 101 in accordance with the teachings of the present invention. As shown, wafer 601 includes a first semiconductor layer 603, a buried insulating layer 605 and a second semiconductor layer 607. In one embodiment, first and second semiconductor layers 603 and 607 include silicon and buried insulating layer 605 includes an oxide.

In the embodiment shown in FIG. 7, the first semiconductor layer 603 is etched away using mask 501, as shown for example in FIG. 5, as a mask. As shown, an opening 701 is formed in semiconductor material layer 503 down to buried insulating layer 605. In one embodiment, mask 501 is a relatively large rectangular mask and therefore enables opening 701 to provide access to buried insulating layer 605 to later etch an opening for buried tapered waveguide 105.

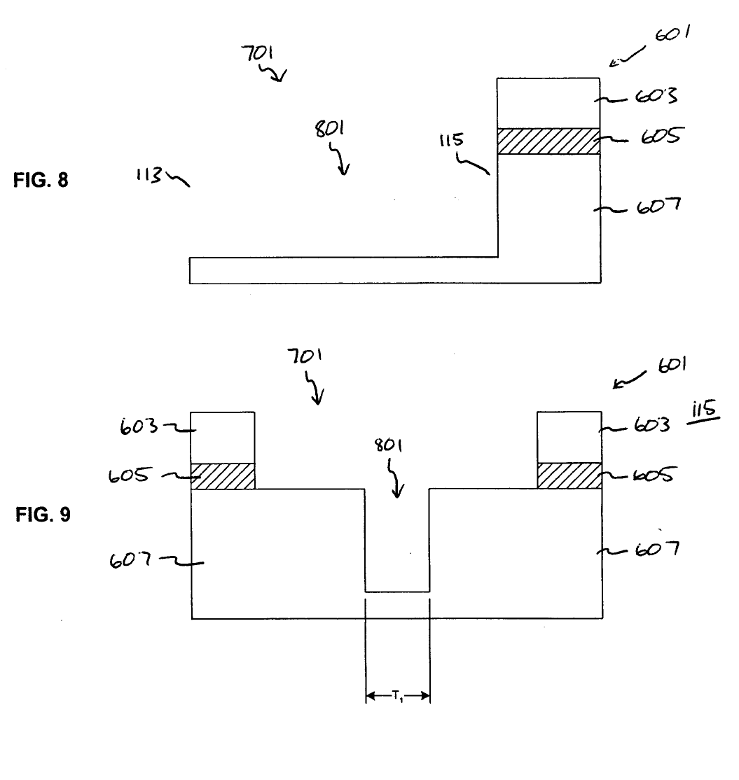

FIG. 8 shows a side view of wafer 601 after buried insulating layer 605 and second semiconductor layer 607 are etched using the mask 503, as shown for example in FIG. 5, to form an opening 801 for the buried tapered waveguide 105. In the embodiment depicted in FIG. 8, the larger end 113 of the dual taper waveguide device 101 will be on the left hand side of the diagram and the smaller end 115 will be on the right hand side.

FIG. 9 is a front view diagram illustrating one embodiment of a cross section of wafer 601 at the tip or smaller end 115 of where dual taper waveguide device 101 will be formed in accordance with the teachings of the present invention. It is noted that views of the openings 701 and 801 formed by the masks 501 and 503, respectfully, can be better appreciated in FIG. 9. In the embodiment shown in FIG. 9, the tip or smaller end 115 of the opening 801 for the buried tapered waveguide 105 has a width of T₁. In one embodiment, T₁ is the critical dimension (CD) or is the minimum width possible for the lithographic process used to etch opening 801. For example, in one embodiment, T₁ is approximately 1.135 μm.

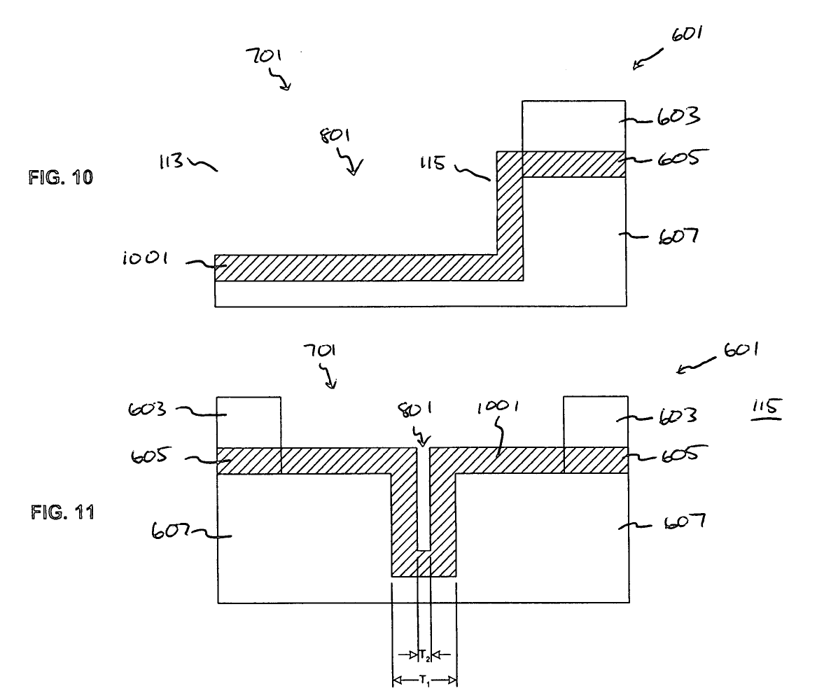

FIG. 10 shows a side view of wafer 601 after an insulating layer 1001 is grown in the opening 801 formed previously. In one embodiment, insulating layer 1001 includes oxide and is grown to a thickness of approximately 0.5 μm thick. As such, insulating layer provides vertical as well as horizontal confinement of an optical beam propagating through buried tapered waveguide 105 in accordance with the teachings of the present invention.

FIG. 11 is a front view diagram illustrating one embodiment of a cross section of wafer 601 at the tip or front end 115 after the insulating layer 1001 is grown in the opening 801 in accordance with the teachings of the present invention. As can be noted in the embodiment depicted in FIG. 11, the tip or smaller end 115 of the opening 801 for the buried tapered waveguide 105 now has a width of only T₂ after the insulating layer 1001 is grown. As a result, the tip or smaller end 115 of the opening 801 has been sharpened or reduced in size from T₂, as illustrated in FIG. 8 to T₁ by growing insulating layer 1001 in accordance with the teachings of the present invention. In one embodiment, T₂ has a width of only approximately 0.206 μm. Therefore, by growing insulating layer 1001, relatively low-cost and low-resolution lithography tools may be utilized to create a sharp tip at the smaller end of the opening 801. Moreover, the sharpness of the tip can receive critical dimensions that are beyond conventional lithography capabilities in accordance with the teachings of the present invention.

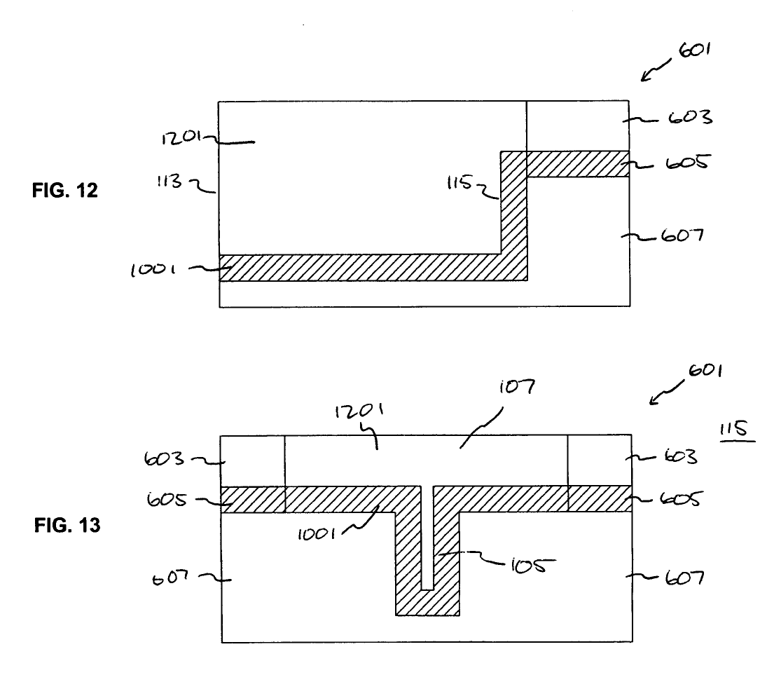

FIG. 12 is a side view diagram illustrating one embodiment of wafer 601 after semiconductor material 1201 is grown in and over the opening 801 and the insulating layer 1001. In one embodiment, semiconductor material 1201 includes epitaxial lateral overgrowth (ELO) silicon. In one embodiment, the material of semiconductor material 1201 will be the core material of the buried tapered waveguide 105 and the tapered rib waveguide 107 of the dual taper waveguide device 101 in accordance with the teachings of the present invention.

FIG. 13 is a front view diagram illustrating one embodiment of a cross section of wafer 601 at the tip or front end 115 after the ELO silicon of semiconductor material 1201 is grown in accordance with the teachings of the present invention. As can be appreciated from the depicted embodiment, the tip or front end 115 of buried tapered waveguide 105 is sharp as defined by insulating layer 1001. Tapered rib waveguide 107 will be adjoining buried tapered waveguide 105 from above, as illustrated in the embodiment depicted in FIG. 13.

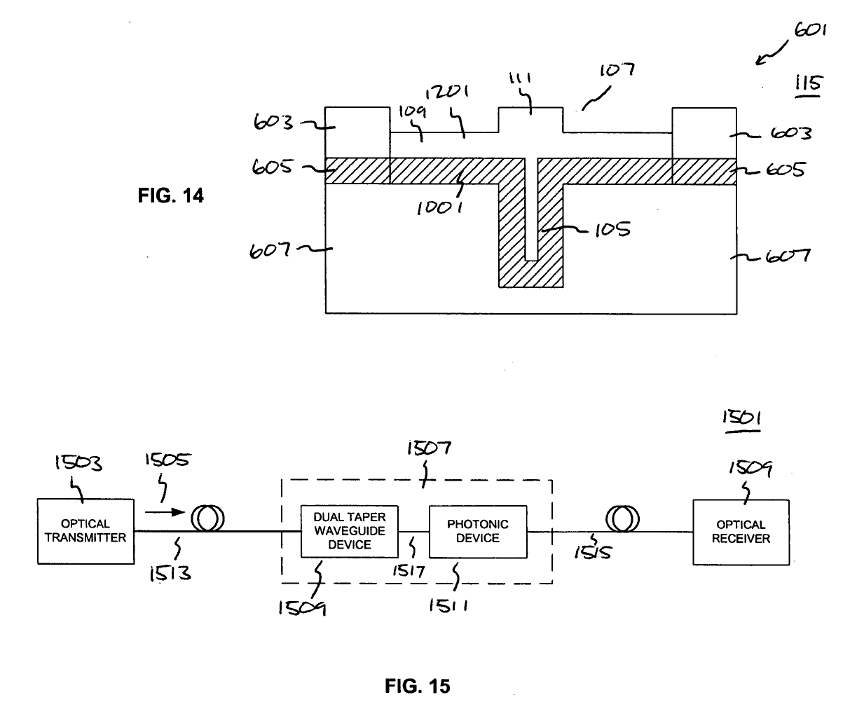

In one embodiment, after semiconductor material 1201 is grown, it is then polished and then the rib portion 111 of tapered rib waveguide 107 is then patterned using mask 505, as illustrated in FIG. 5. To illustrate, FIG. 14 provides an illustration of one embodiment of a front view diagram of the cross section of wafer 601 at the tip or front end 115 after tapered rib waveguide 107 is then patterned using mask 505 in accordance with the teachings of the present invention. As can be appreciated from the depicted embodiment, the rib portion 111 and slab portion 109 are now defined in the ELO silicon of semiconductor material 1201. The slab portion of 109 of tapered rib waveguide 107 is adjoining buried tapered waveguide 105 from above as shown. It is noted that the cross section view of dual taper waveguide device 101 at the larger end 113 is as it appears and is described above in FIG. 3.

FIG. 15 is a block diagram illustration of one embodiment of a system 1501 including one embodiment a semiconductor device including a dual taper waveguide device and a photonic device according to embodiments of the present invention. As illustrated in the depicted embodiment, system 1501 includes an optical transmitter 1505 to output an optical beam 1505. System 1501 also includes an optical receiver 1509 and an optical device 1507 is optically coupled between the optical transmitter 1503 and optical receiver 1509. In one embodiment, the optical device 1507 includes semiconductor material, such as for example a silicon layer in a chip, with a dual taper waveguide device 1509 and a photonic device 1511 included therein. In one embodiment, dual taper waveguide device 1509 is substantially similar to dual taper waveguide device 101 described in FIGS. 1-13 above. In one embodiment, dual taper waveguide device 101 and photonic device 1511 are semiconductor-based devices that are provided in a fully integrated solution on a single integrated circuit chip.

In operation, optical transmitter 1503 transmits optical beam 1505 to optical device 1507 through an optical fiber 1513. Optical fiber 1513 is then optically coupled to optical device 1507 such that optical beam 1507 is received at an input to dual taper waveguide device 1509. In one embodiment, the input to dual taper waveguide device 1509 corresponds to the larger end 113 of dual taper waveguide device 1509. Accordingly, with dual taper waveguide device 1509, the mode size of optical beam 1505 is reduced in sized such that a photonic device 1511 receives optical beam 1505 through a single mode waveguide 1517 disposed in the semiconductor material of optical device 1507. In one embodiment, photonic device 1511 may include any known semiconductor-based photonic optical device including for example, but not limited to, an optical phase shifter, modulator, switch or the like. After optical beam 1505 is output from photonic device 1511, it is then optically coupled to be received by optical receiver 1509. In one embodiment, optical beam 1505 is propagated through an optical fiber 1515 to propagate from optical device 1507 to optical receiver 1509.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

1. An apparatus, comprising:
a buried tapered waveguide disposed in a semiconductor layer; and
a tapered rib waveguide disposed in the semiconductor layer proximate to the buried tapered waveguide, the tapered rib waveguide including a rib portion adjoining a slab portion, the slab portion of the rib waveguide adjoining the buried tapered waveguide, wherein an optical beam is directed into a larger end of the buried tapered waveguide and the tapered rib waveguide, the buried tapered waveguide tapered to guide the optical beam therethrough into the slab portion of the rib waveguide.

2. The apparatus of claim 1 further comprising an insulator disposed in the semiconductor layer, the insulator surrounding and serving as cladding for the buried tapered waveguide to provide vertical and lateral optical confinement in the buried tapered waveguide.

3. The apparatus of claim 2 wherein a smaller end of the buried tapered waveguide opposite the larger end of the buried tapered waveguide is defined by the insulator disposed in the semiconductor layer.

4. The apparatus of claim 3 wherein the insulator comprises oxide grown in a tapered trench etched from the semiconductor layer.

5. The apparatus of claim 3 wherein the buried tapered waveguide and the tapered rib waveguide comprise epitaxial lateral overgrowth (ELO) silicon defined within the oxide.

6. The apparatus of claim 1 wherein the buried tapered waveguide includes a first and second taper regions, the first taper region tapering at a first taper rate from the larger end of the buried tapered waveguide to the second taper region of the buried tapered waveguide, the second taper region tapering at a second taper rate from the first taper region of the buried tapered waveguide to a smaller end of the buried tapered waveguide, wherein the first taper rate is greater than the second taper rate.

7. The apparatus of claim 1 wherein the tapered rib waveguide includes a first and second taper regions, the first taper region tapering at a third taper rate from the larger end of the tapered rib waveguide to the second taper region of the tapered rib waveguide, the second taper region tapering at a fourth taper rate from the first taper region of the tapered rib waveguide to a smaller end of the tapered rib waveguide, wherein the third taper rate is greater than the fourth taper rate.

8. A method, comprising:
directing an optical beam into a larger end of a buried tapered waveguide and a tapered rib waveguide disposed in a semiconductor layer, the tapered rib waveguide including a rib portion adjoining a slab portion, the slab portion of the rib waveguide adjoining the buried tapered waveguide;
directing a mode of the optical beam propagating through the buried tapered waveguide into the slab portion of the rib waveguide adjoining the buried tapered waveguide; and
outputting substantially all of the optical beam directed into the larger end of the buried tapered waveguide and the tapered rib waveguide from a smaller end of the tapered rib waveguide, the smaller end of the tapered rib waveguide opposite the larger end of the tapered rib waveguide.

9. The method of claim 8 further comprising shrinking a mode size of the optical beam from a larger mode size when directed into the larger end of the buried tapered waveguide and the tapered rib waveguide to a smaller mode size when output from the smaller end of the tapered rib waveguide.

10. The method of claim 9 wherein shrinking the mode size of the optical beam comprises:
shrinking the mode size of the optical beam at a first taper rate when the optical beam is directed into the larger end of the buried tapered waveguide and the tapered rib waveguide; and
shrinking the mode size of the optical beam at a second taper rate when directing the mode of the optical beam propagating through the buried tapered waveguide into the slab portion of the rib waveguide adjoining the buried tapered waveguide.

11. The method of claim 10 wherein the first taper rate is greater than the second taper rate.

12. The method of claim 8 wherein directing the optical beam into the larger end of the buried tapered waveguide and the tapered rib waveguide includes directing the optical beam from an optical fiber.

13. The method of claim 8 further comprising directing the optical beam from the smaller end of the tapered rib waveguide into a semiconductor photonic device disposed in the semiconductor layer.

14. A method, comprising:
etching a first semiconductor layer of a silicon-on-insulator (SOI) wafer with a first mask;
etching a buried taper opening into a second semiconductor layer of the SOI wafer with a buried taper mask, the buried taper mask having a larger end and a smaller end;
growing an insulating layer in the buried taper opening;
growing silicon in and over the buried taper opening over the insulator layer to form a buried tapered waveguide; and
patterning a tapered rib waveguide in the silicon grown over the buried tapered waveguide using a tapered rib waveguide mask such that a slab portion of the tapered rib waveguide adjoins the buried tapered waveguide, the tapered rib waveguide having a larger end and a smaller end corresponding to the larger and smaller ends, respectively, of the buried tapered waveguide.

15. The method of claim 14 further comprising sharpening a tip of the buried tapered waveguide defined at the smaller end of the buried taper opening by growing the insulating layer in the buried taper opening.

16. The method of claim 14 wherein etching the buried taper opening into the second semiconductor layer of the SOI wafer with the buried taper mask includes defining first and second taper regions in the buried tapered waveguide, the first taper region of the buried tapered waveguide to taper at a first taper rate from the larger end of the buried tapered waveguide to the second taper region of the buried tapered waveguide, the second taper region of the buried tapered waveguide to taper at a second taper rate from the first taper region of the buried tapered waveguide to the smaller end of the buried tapered waveguide.

17. The method of claim 16 wherein the first taper rate greater than the first taper rate is greater than the second taper rate.

18. The method of claim 14 wherein patterning the tapered rib waveguide in the silicon grown over the buried tapered waveguide using the tapered rib waveguide mask includes defining first and second taper regions in the tapered rib waveguide, the first taper region of the tapered rib waveguide to taper at a third taper rate from the larger end of the tapered rib waveguide to the second taper region of the tapered rib waveguide, the second taper region of the tapered rib waveguide to taper at a fourth taper rate from the first taper region of the tapered rib waveguide to the smaller end of the tapered rib waveguide.

19. The method of claim 18 wherein the third taper rate greater than the fourth taper rate.

20. The method of claim 14 further comprising optically coupling an optical fiber to the larger ends of the buried tapered waveguide and the tapered rib waveguide.

21. The method of claim 14 further comprising optically coupling a photonic device disposed in the SOI wafer to the smaller end of the tapered rib waveguide.

22. A system, comprising:
an optical transmitter to transmit an optical beam;
an optical receiver; and
an optical device disposed between the optical transmitter and the optical receiver, the optical device including:
a buried tapered waveguide disposed in a semiconductor layer;
a tapered rib waveguide disposed in the semiconductor layer proximate to the buried tapered waveguide, the tapered rib waveguide including a rib portion adjoining a slab portion, the slab portion of the rib waveguide adjoining the buried tapered waveguide, wherein an optical beam is directed into a larger end of the buried tapered waveguide and the tapered rib waveguide, the buried tapered waveguide tapered to guide the optical beam therethrough into the slab portion of the rib waveguide; and
a photonic device disposed in the semiconductor layer optically coupled to the smaller end of the tapered rib waveguide,
the optical beam optically coupled to be received from the optical transmitter by the buried tapered waveguide and the tapered rib waveguide, the optical to be directed from the tapered rib waveguide through the photonic device to the optical receiver.

23. The system of claim 22 further comprising an optical fiber optically coupled between the optical transmitter and the buried tapered waveguide and the tapered rib waveguide.

24. The system of claim 22 wherein the optical device further comprises an insulator disposed in the semiconductor layer, the insulator surrounding and serving as cladding for the buried tapered waveguide to provide vertical and lateral optical confinement in the buried tapered waveguide.

25. The system of claim 24 wherein a smaller end of the buried tapered waveguide opposite the larger end of the buried tapered waveguide is defined by the insulator disposed in the semiconductor layer.

26. The system of claim 22 wherein the buried tapered waveguide includes a first and second taper regions, the first taper region tapering at a first taper rate from the larger end of the buried tapered waveguide to the second taper region of the buried tapered waveguide, the second taper region tapering at a second taper rate from the first taper region of the buried tapered waveguide to a smaller end of the buried tapered waveguide, wherein the first taper rate is greater than the second taper rate.

27. The system of claim 22 wherein the tapered rib waveguide includes a first and second taper regions, the first taper region tapering at a third taper rate from the larger end of the tapered rib waveguide to the second taper region of the tapered rib waveguide, the second taper region tapering at a fourth taper rate from the first taper region of the tapered rib waveguide to a smaller end of the tapered rib waveguide, wherein the third taper rate is greater than the fourth taper rate.
